(19) United States
(12) Patent Application Publication
(10) Pub. No.: US 2025/0053870 A1
(43) Pub. Date: Feb. 13, 2025

(54) SWITCHING MACHINE LEARNING FUNCTIONALITY BASED ON RESOURCE AVAILABILITY

(71) Applicant: Nokia Technologies Oy, Espoo (FI)

(72) Inventors: Taylan SAHIN, Munich (DE); Prajwal KESHAVAMURTHY, Munich (DE); Diomidis MICHALOPOULOS, Munich (DE); Dick CARRILLO MELGAREJO, Espoo (FI)

(21) Appl. No.: 18/788,494

(22) Filed: Jul. 30, 2024

Related U.S. Application Data
(60) Provisional application No. 63/531,685, filed on Aug. 9, 2023.

(51) Int. Cl. G06N 20/00

(52) U.S. Cl. CPC G06N 20/00

(57) ABSTRACT

Systems, methods, apparatuses, and computer program products for a switching machine learning functionality based on resource availability. A method may include executing a machine learning functionality, feature, or model at a first network element. The method may also include monitoring a machine learning resource at the first network element that impacts performance of the machine learning functionality, feature, or model. The method may further include indicating, to a second network element based on the monitoring, a machine learning-related resource availability impacting performance of the machine learning functionality, feature, or model. In addition, the method may include receiving, from a third network element, a configuration for an action to be executed by the first network element based on the machine learning-related resource availability impacting performance of the machine learning functionality, feature, or model. Further, the method may include executing the action.

### CROSS REFERENCE TO RELATED APPLICATION

This application claims the benefit of U.S. provisional application No. 63/531,685 filed on 9 Aug. 2023, which is incorporated herein by reference in its entirety.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for switching machine learning functionality based on resource availability.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include executing a machine learning functionality, feature, or model at a first network element. The method may also include monitoring a machine learning resource at the first network element that impacts performance of the machine learning functionality, feature, or model. The method may further include indicating, to a second network element based on the monitoring, a machine learning-related resource availability impacting performance of the machine learning functionality, feature, or model. In addition, the method may include receiving, from a third network element, a configuration for an action to be executed by the first network element based on the machine learning-related resource availability impacting performance of the machine learning functionality, feature, or model. Further, the method may include executing the action.

Other example embodiments may be directed to an apparatus. The apparatus may include at least one processor and at least one memory including computer program code. The at least one memory and the computer program code may be configured to, with the at least one processor, cause the apparatus at least to execute a machine learning functionality, feature, or model at the apparatus. The apparatus may also be caused to monitor a machine learning resource at the apparatus that impacts performance of the machine learning functionality, feature, or model. The apparatus may further be caused to indicate, to a first network element based on the monitoring, a machine learning-related resource availability impacting performance of the machine learning functionality, feature, or model. In addition, the apparatus may be caused to receive, from a second network element, a configuration for an action to be executed by the apparatus based on the machine learning-related resource availability impacting performance of the machine learning functionality, feature, or model. Further, the apparatus may be caused to execute the action.

Other example embodiments may be directed to an apparatus. The apparatus may include means for executing a machine learning functionality, feature, or model at the apparatus. The apparatus may also include means for monitoring a machine learning resource at the apparatus that impacts performance of the machine learning functionality, feature, or model. The apparatus may further include means for indicating, to a first network element based on the monitoring, a machine learning-related resource availability impacting performance of the machine learning functionality, feature, or model. In addition, the apparatus may include means for receiving, from a second network element, a configuration for an action to be executed by the apparatus based on the machine learning-related resource availability impacting performance of the machine learning functionality, feature, or model. Further, the apparatus may include means for executing the action.

In accordance with other example embodiments, a non-transitory computer readable medium may be encoded with instructions that may, when executed in hardware, perform a method. The method may include executing a machine learning functionality, feature, or model at a first network element. The method may also include monitoring a machine learning resource at the first network element that impacts performance of the machine learning functionality, feature, or model. The method may further include indicating, to a second network element based on the monitoring, a machine learning-related resource availability impacting performance of the machine learning functionality, feature, or model. In addition, the method may include receiving, from a third network element, a configuration for an action to be executed by the first network element based on the machine learning-related resource availability impacting performance of the machine learning functionality, feature, or model. Further, the method may include executing the action.

Other example embodiments may be directed to a computer program product that performs a method. The method may include executing a machine learning functionality, feature, or model at a first network element. The method may also include monitoring a machine learning resource at the first network element that impacts performance of the machine learning functionality, feature, or model. The method may further include indicating, to a second network element based on the monitoring, a machine learning-related resource availability impacting performance of the machine learning functionality, feature, or model. In addition, the method may include receiving, from a third network element, a configuration for an action to be executed by the first network element based on the machine learning-related resource availability impacting performance of the machine learning functionality, feature, or model. Further, the method may include executing the action.

Other example embodiments may be directed to an apparatus that may include circuitry configured to execute a machine learning functionality, feature, or model at the apparatus. The apparatus may also include circuitry configured to monitor a machine learning resource at the apparatus that impacts performance of the machine learning functionality, feature, or model. The apparatus may further include circuitry configured to indicate, to a first network element based on the monitoring, a machine learning-related resource availability impacting performance of the machine learning functionality, feature, or model. In addition, the apparatus may include circuitry configured to receive, from a second network element, a configuration for an action to be executed by the apparatus based on the machine learning-related resource availability impacting performance of the machine learning functionality, feature, or model. Further, the apparatus may include circuitry configured to execute the action.

Some example embodiments may be directed to a method. The method may include receiving, from a first network element, a machine learning-related resource availability impacting performance of a machine learning functionality, feature, or model executed by the first network element. The method may also include determining, based on the machine learning-related resource availability impacting performance of the machine learning functionality, feature, or model, a performance of the machine learning functionality, feature, or model. The method may further include transmitting an indication to a second network entity or the first network element indicating the performance of the machine learning functionality, feature, or model.

Other example embodiments may be directed to an apparatus. The apparatus may include at least one processor and at least one memory including computer program code. The at least one memory and the computer program code may be configured to, with the at least one processor, cause the apparatus at least to receive, from a first network element, a machine learning-related resource availability impacting performance of a machine learning functionality, feature, or model executed by the first network element. The apparatus may also be caused to determine, based on the machine learning-related resource availability impacting performance of the machine learning functionality, feature, or model, a performance of the machine learning functionality, feature, or model. The apparatus may further be caused to transmit an indication to a second network entity or the first network element indicating the performance of the machine learning functionality, feature, or model.

Other example embodiments may be directed to an apparatus. The apparatus may include means for receiving, from a first network element, a machine learning-related resource availability impacting performance of a machine learning functionality, feature, or model executed by the first network element. The apparatus may also include means for determining, based on the machine learning-related resource availability impacting performance of the machine learning functionality, feature, or model, a performance of the machine learning functionality, feature, or model. The apparatus may further include means for transmitting an indication to a second network entity or the first network element indicating the performance of the machine learning functionality, feature, or model.

In accordance with other example embodiments, a non-transitory computer readable medium may be encoded with instructions that may, when executed in hardware, perform a method. The method may include receiving, from a first network element, a machine learning-related resource availability impacting performance of a machine learning functionality, feature, or model executed by the first network element. The method may also include determining, based on the machine learning-related resource availability impacting performance of the machine learning functionality, feature, or model, a performance of the machine learning functionality, feature, or model. The method may further include transmitting an indication to a second network entity or the first network element indicating the performance of the machine learning functionality, feature, or model.

Other example embodiments may be directed to a computer program product that performs a method. The method may include receiving, from a first network element, a machine learning-related resource availability impacting performance of a machine learning functionality, feature, or model executed by the first network element. The method may also include determining, based on the machine learning-related resource availability impacting performance of the machine learning functionality, feature, or model, a performance of the machine learning functionality, feature, or model. The method may further include transmitting an indication to a second network entity or the first network element indicating the performance of the machine learning functionality, feature, or model.

Other example embodiments may be directed to an apparatus that may include circuitry configured to receive, from a first network element, a machine learning-related resource availability impacting performance of a machine learning functionality, feature, or model executed by the first network element. The apparatus may also include circuitry configured to determine, based on the machine learning-related resource availability impacting performance of the machine learning functionality, feature, or model, a performance of the machine learning functionality, feature, or model. The apparatus may further include circuitry configured to transmit an indication to a second network entity or the first network element indicating the performance of the machine learning functionality, feature, or model.

Some example embodiments may be directed to a method. The method may include receiving, from a first network entity, an indication indicating a performance of a machine learning functionality, feature, or model executed by a second network entity. The method may also include determining, based on the indication, an action to be executed by the second network element based on the indication. The method may further include configuring the second network element to execute the action that complies with a machine learning-related resource availability impacting performance of the machine learning functionality, feature, or model at the second network element.

Other example embodiments may be directed to an apparatus. The apparatus may include at least one processor and at least one memory including computer program code. The at least one memory and the computer program code may be configured to, with the at least one processor, cause the apparatus at least to receive, from a first network entity, an indication indicating a performance of a machine learning functionality, feature, or model executed by a second network entity. The apparatus may also be caused to determine, based on the indication, an action to be executed by the second network element based on the indication. The apparatus may further be caused to configure the second network element to execute the action that complies with a machine learning-related resource availability impacting performance of the machine learning functionality, feature, or model at the second network element.

Other example embodiments may be directed to an apparatus. The apparatus may include means for receiving, from a first network entity, an indication indicating a performance of a machine learning functionality, feature, or model executed by a second network entity. The apparatus may also include means for determining, based on the indication, an action to be executed by the second network element based on the indication. The apparatus may further include means for configuring the second network element to execute the action that complies with a machine learning-related resource availability impacting performance of the machine learning functionality, feature, or model at the second network element.

In accordance with other example embodiments, a non-transitory computer readable medium may be encoded with instructions that may, when executed in hardware, perform a method. The method may include receiving, from a first network entity, an indication indicating a performance of a machine learning functionality, feature, or model executed by a second network entity. The method may also include determining, based on the indication, an action to be executed by the second network element based on the indication. The method may further include configuring the second network element to execute the action that complies with a machine learning-related resource availability impacting performance of the machine learning functionality, feature, or model at the second network element.

Other example embodiments may be directed to a computer program product that performs a method. The method may include receiving, from a first network entity, an indication indicating a performance of a machine learning functionality, feature, or model executed by a second network entity. The method may also include determining, based on the indication, an action to be executed by the second network element based on the indication. The method may further include configuring the second network element to execute the action that complies with a machine learning-related resource availability impacting performance of the machine learning functionality, feature, or model at the second network element.

Other example embodiments may be directed to an apparatus that may include circuitry configured to receive, from a first network entity, an indication indicating a performance of a machine learning functionality, feature, or model executed by a second network entity. The apparatus may also include circuitry configured to determine, based on the indication, an action to be executed by the second network element based on the indication. The apparatus may further include circuitry configured to configure the second network element to execute the action that complies with a machine learning-related resource availability impacting performance of the machine learning functionality, feature, or model at the second network element.

### BRIEF DESCRIPTION OF THE DRAWINGS

For proper understanding of example embodiments, reference should be made to the accompanying drawings, wherein:

FIG. 1 an example signal diagram, according to certain example embodiments.

FIG. 2 illustrates another example signal diagram, according to certain example embodiments.

FIG. 3 illustrates an example flow diagram of a method, according to certain example embodiments.

FIG. 4 illustrates an example flow diagram of another method, according to certain example embodiments.

FIG. 5 illustrates an example flow diagram of a further method, according to certain example embodiments.

FIG. 6 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for switching machine learning functionality based on resource availability.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably. Additionally, the terms machine learning (ML) and artificial intelligence (AI) throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The technical specifications of the 3rd Generation Partnership Project (3GPP) describe assessments on potential impacts of certain protocol aspects (e.g., radio access network 2 (RAN2)), and considers aspects related to, for example, capability indication, configuration and control procedures (e.g., training/inference), and management of data and AI/ML model, per RAN1 input. Life cycle management (LCM) of an AI/ML model may include certain aspects such as, for example, data collection, model training, functionality/model identification, model transfer, model inference operation, functionality/model selection, activation, deactivation, switching, fallback operation, decision by a network (NW) or a user equipment (UE), functionality/model monitoring, model update, and UE capability.

In the technical specifications of 3GPP, LCM procedures may be based on an AI/ML model having a model ID with associated information and/or model functionality at least for some AI/ML operations. In functionality-based LCM, the NW may indicate activation, deactivation, fallback, or switching of AI/ML functionality via 3GPP signaling (e.g., radio resource control (RRC), medium access control-control element (MAC-CE), and/or downlink control information (DCI)). In some instances, models may not be identified at the NW, and the UE may perform model-level LCM. For functionality identification, there may be one or more than one functionality defined within an AI/ML-enabled feature, whereby the AI/ML-enabled feature refers to a feature where AI/ML may be used.

For AI/ML functionality identification and functionality-based LCM of UE-side models and/or UE-part of two-sided models, functionality refers to an AI/ML-enabled featured/feature group (FG) enabled by a certain configuration(s). The configuration(s) may be supported based on conditions indicated by UE capability, and functionality-based LCM may operate based on at least one configuration of an AI/ML-enabled feature/FG or specific configurations of an AI/ML-enabled feature/FG.

In model-ID-based LCM, models may be identified at the NW, and the NW/UE may activate, deactivate, select, or switch individual AI/ML models via a model ID. For AI/ML model identification and model-ID-based LCM of UE-side models and/or the UE-part of two-sided models, model-ID-based LCM may operate based on identified models. A model may be associated with specific configurations or conditions associated with the UE capability of an AI/ML-enabled feature/FG and additional conditions (e.g., scenarios, sites, and datasets) as determined/identified between the UE-side and the NW-side. From the RAN1 perspective, an AI/ML model identified by a model ID may be logical, and how it maps to a physical AI/ML model(s) may depend on implementation. An AI/ML model may be a data driven algorithm that applies AI/ML techniques to generate a set of outputs based on a set of inputs.

According to certain example embodiments, certain conditions may need to be defined to achieve practical and effective AI/ML solutions and selection, activation, deactivation, switching, and fallback of AI/ML functionalities or models at the UE. The UE capabilities associated with an AI/ML-enabled feature/FG relating to a certain AI/ML functionality and/or AI/ML model may be considered. While the capability of a UE may be static (i.e., not expected to change within a relatively short time frame), there may also be dynamic conditions that impact whether a UE can utilize/switch to a certain AI/ML functionality/model at a certain time. For instance, the dynamic conditions may include, but not be limited to, availability of resources, such as the processing power at a UE to perform certain AI/ML functions.

In one example scenario, a certain AI/ML model of the UE may perform a task such as, for example, position estimation as expected in a certain environment and situation. The UE in this example may not be able to run the AI/ML model due to an overloaded CPU that is prioritized for other tasks at the UE. Thus, the overloaded CPU may result in an unexpected but temporary drop in the performance of the AI/ML model. In this scenario, switching to another model with similar complexity may not help as the UE is already constrained by its processing power. Thus, one option to resolve this issue could be to switch to a model or fallback to a non-AI/ML solution that has less computational complexity. However, there is currently no mechanism defined to address such model selection, activation, deactivation, switching, and fallback under such resource-constrained situations at the UE side. Accordingly, as described herein, certain example embodiments may provide ways to select, activate, deactivate, switch, and fallback AI/ML-enabled feature(s), functionalities, or models at the UE-side depending on conditions of AI/ML-related resource availability at the UE side. However, such solutions described herein of certain example embodiments may not be limited to just the UE-side, but may also be applicable to the network (e.g., gNB) side.

According to certain example embodiments, the UE may be configured or triggered to monitor its AI/ML-related resources at the UE-side that may impact performance of an AI/ML-enabled feature, AI/ML functionality or model, and indicate these dynamic conditions to an AI/ML performance monitoring entity (also referred to as “performance monitoring entity”) at the network (NW) (e.g., a core network entity such as a network data analytics function (NWDAF), a network node, or functionality such as, for example, a location management function (LMF) in the case of a positioning use case, or a gNB for CSI or beam-management use cases). According to some example embodiments, the performance monitoring entity may monitor the inference performance of the AI/ML model, and/or may derive a monitoring metric (e.g., statistics of measurement(s) compared to the statistics associated with training data; statistics of the difference between model output and provided ground truth label). In certain example embodiments, the AI/ML-related resources may include, but not be limited to, for example, processing power, battery status, memory availability, etc.

In certain example embodiments, once the performance monitoring entity receives the report of the dynamic conditions from the UE, the performance monitoring entity may determine the AI/ML feature, functionality, or model performance based on the indicated AI/ML-related resource availability at the UE. The performance monitoring entity may also indicate the monitoring outcome to an AI/ML functionality managing entity (also referred to as the “functionality managing entity”) at the NW. In some example embodiments, the functionality managing entity may be another core network entity or functionality such as, for example, a gNB, an NWDAF, a functionality management module (FMM) in the network.

According to certain example embodiments, the functionality management entity may determine to whether a selection, activation, deactivation, switching, or fallback of an AI/ML-enabled feature, AI/ML functionality or models should be performed at the UE based on the monitoring outcome. The functionality management entity may also provide a related configuration to the UE such as, for example, a configuration to switch to a certain AI/ML model that could comply with the resource availability at the UE-side. In this way, it may be possible for certain example embodiments to make more efficient decisions on LCM of AI/ML-enabled features by taking into account dynamic (and unforeseen) conditions at the UE-side related to AI/ML-enabling resources.

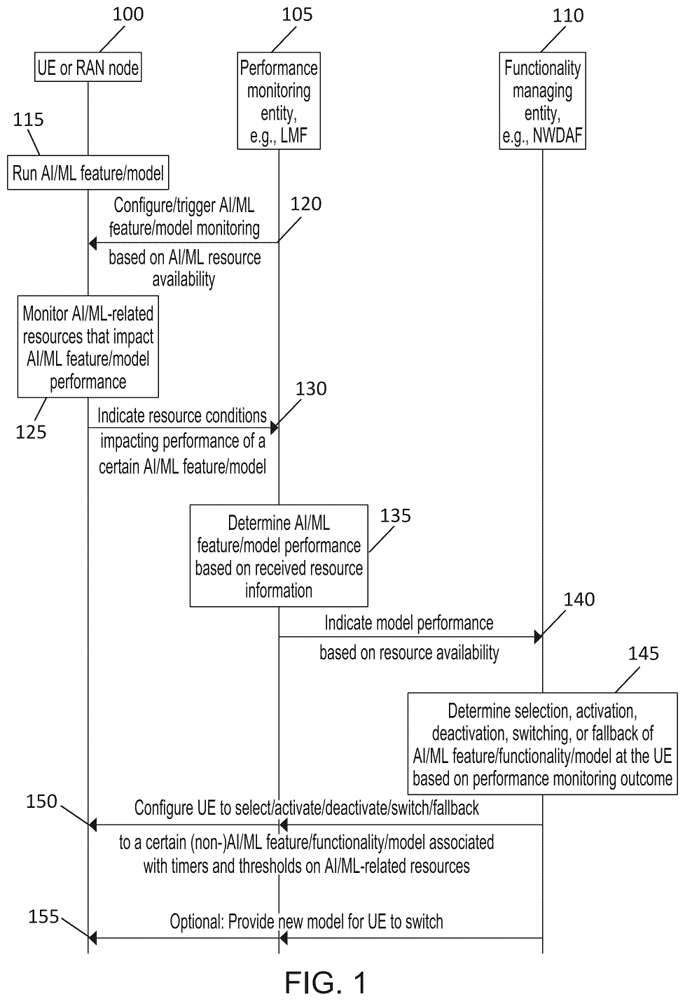

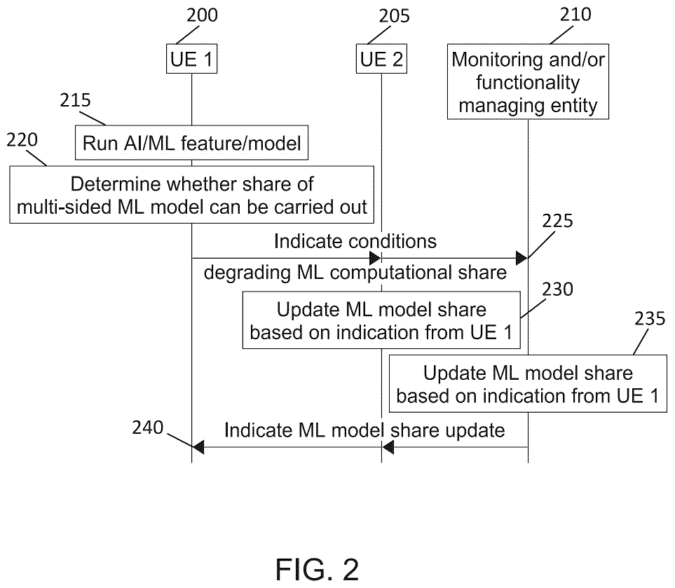

FIG. 1 illustrates an example signaling diagram, according to certain example embodiments. As described herein with respect to the example of FIGS. 1 and 2, the UE may be replaced by a radio access network (RAN) node such as, for example, a gNB, and all described features of certain example embodiments related to the UE may be applicable to a gNB as well. Additionally, like the UE, the gNB may also have AI/ML-enabled feature(s), functionality(ies), or model(s).

As illustrated in FIG. 1, at 115, the UE or RAN node 100 runs an AI/ML feature/model. At 120, the performance monitoring entity 105 (e.g., LMF in the case of a positioning use case) configures or triggers the UE or RAN node 100 to monitor its resource availability that impact AI/ML feature/functionality/model at the UE or RAN node side.

In certain example embodiments, the configuration and trigger of the UE or RAN node 100 may be optional, and the UE or RAN node 100 may trigger itself to execute performance monitoring. In other example embodiments, the performance monitoring entity may be a core network node/function, a RAN node/function, or a UE node/function.

At 125, the UE or RAN node 100 monitors its AI/ML-related resources that may impact the performance of an AI/ML feature/model/functionality performance at the UE or RAN node side. In certain example embodiments, the AI/ML-related resources may include, but not limited to, for example, processing power (e.g., at the graphics processing unit (GPU), central processing unit (CPU), and/or tensor processing unit (TPU)), available memory (e.g., random access memory (RAM) and/or read-only memory (ROM)), electrical power (e.g., battery status), device input/output conditions (e.g., sensor blocked, sensor data missing, etc.), and/or device connection status (e.g., UL/DL throughput, link quality, etc.).

At 130, the UE or RAN node 100 may indicate to the performance monitoring entity 105 AI/ML-related resource availability of the UE or RAN node 100, via a binary indication, a duration of the (degraded) performance status, or a detailed information/update on the status of the AI/ML-related resources. In certain example embodiments, the indication may relate to a past performance status, current status, or an expected future status. For instance, in certain example embodiments, the binary indication may be an indication of whether or not there are sufficient AI/ML-related resources at the UE-side to run a specified AI/ML-enabled feature, and/or AI/ML functionality or model (e.g., indicated by a functionality ID, model ID, etc.). In other example embodiments, the duration of the (degraded) performance status may include, for example, how long the UE or RAN node can or cannot perform the AI/ML functionality as desired. In certain example embodiments, the performance status may also be related to space including, for example, a geographical area, cell, etc. Additionally, the performance status may be any performance status including but not limited to, for example, that resources were sufficient to perform a specific functionality. The performance of the UE or RAN node 100 may be dependent upon their corresponding CPU schedule. Additionally, in some example embodiments, the detailed information/update on the status of the AI/ML-related resources may include, for example, a remaining battery power, the CPU availability, the memory usage, an amount or percentage of (consumed/required or available) power or memory, and others.

At 135, the performance monitoring entity 105 evaluates the provided information from the UE or RAN node 100 on AI/ML-related resource availability to determine the performance of the AI/ML-enabled feature, AI/ML functionality, or models at the UE or RAN node 100. For instance, in some example embodiments, the performance may correspond to ML inference performance. In an example embodiment, if the MIL task is to estimate UE location (“direct AI/ML positioning”), it should be accurate enough so a performance metric could be the error of the absolute location estimation in a certain coordinate system. Additionally, for an evaluation of AI/ML assisted positioning where the ML task is to estimate an intermediate positioning-related feature, the various intermediate performance metrics may be used including, for example, line-of-sight (LOS) classification accuracy if the model output includes LOS/non-LOS indicator of hard values where the LOS/NLOS indicator is generated for a link between a UE and total radiated power (TRP). The intermediate performance metric may also include a timing estimation accuracy (expressed in meters) if the model output includes timing estimation (e.g., time of arrival (ToA) reference signal time difference (RSTD)). The intermediate performance metric may further include an angle estimation accuracy (in degrees) if the model includes an angle estimation (e.g., angle of arrival (AoA) or angle of departure (AoD)). At 140, the performance monitoring entity 105 indicates the monitoring outcome to a functionality managing entity 110 (e.g., NWDAF). In certain example embodiments, the functionality managing entity 110 may be responsible for AI/ML feature/functionality/model switching/selection/(de-)activation/fallback. In some example embodiments, the functionality managing entity 110 may be the same entity as the AI/ML performance monitoring entity.

At 145, the functionality managing entity 110 may determine, based on the performance monitoring outcome, one or more of the selection, activation, deactivation, switching, or fallback of the AI/ML feature/functionality/model at the UE or RAN node 100. For instance, at 150, the functionality managing entity 110 may configure the UE or RAN node 100 to select, activate, deactivate, switch, or fallback to a certain AI/ML-enabled feature, an AI/ML functionality or model, or a non-AI/ML functionality. As illustrated in FIG. 1, the functionality managing entity may transmit the configuration directly to the UE or RAN node 100, or transmit the configuration first to performance monitoring entity 105, and the performance monitoring entity 105 transmits the configuration to the UE or gNB node 100. Further, at 150, the functionality managing entity 110 may provide a timer(s) or a threshold(s) on the AI/ML-related resource associated with the above configuration (e.g., to delay a model switch when the CPU is available). Additionally, at 155, the functionality managing entity 110 may optionally provide a new model to the UE or RAN node 100 that the UE or RAN node 100 should switch to. As illustrated in FIG. 1, at 155, the new model may be transmitted directly to the UE or RAN node 100, or provided first to the performance monitoring entity 105, and the performance monitoring entity 105 transmits the new model to the UE or RAN gNB 100.

FIG. 2 illustrates another example signal flow diagram, according to certain example embodiments. For instance, FIG. 2 illustrates a multi-sided ML model, where two or more entities that are involved in a two-sided (or multi-sided) ML model, exchange information with respect to whether their assigned ML-related tasks can be fulfilled as planned, or some (temporal) conditions impacting their performance are being experienced. According to certain example embodiments, depending on the resource conditions at different sides of the model (e.g., at different UEs), the monitoring and/or functionality managing entity 210 may determine to distribute the load of the ML-related task(s) across the sides. For example, the monitoring and/or functionality managing entity 210 may allocate the less power-consuming part of the task to the UE suffering from low resource availability, and the rest of the task to the other UE which has sufficient resources, by configuring related functionalities/models at different sides. The example embodiment illustrated in FIG. 2 may share similar processes as those illustrated in FIG. 1, except that in FIG. 2, the messages flow from one ML entity to another (e.g., one UE running the multi-sided ML model to another UE running the same multi-sided model, or to a network entity (gNB) running the same multi-sided model), indicating that the share of the ML model at one entity cannot be performed as planned.

At 215, UE1 200 runs an AI/ML feature/model. At 220, UE1 200 determines whether the share of the multi-sided ML model with UE2 205 can be carried out. At 225, UE1 200 may indicate the condition(s) that is degrading the ML computational share directly to UE2 205. Alternatively, at 225, UE1 200 may indicate (i.e., transmit) the condition(s) that is degrading the ML computational share first to UE2 205, and UE2 205 may transmit the condition(s) that is degrading the ML computational share to the monitoring and/or functionality managing entity 210. At 230, UE2 205 updates the AI/ML model share based on the indication from UE1 200. Similarly, at 235, the monitoring and/or functionality managing entity 210 updates the ML model share based on the indication from UE1 200. At 240, the monitoring and/or functionality managing entity 210 indicates the ML model share update first to UE2 205, and UE2 205 may transmit the ML model share update to UE1 200. Alternative, the monitoring and/or functionality managing entity 210 may transmit the ML model share update directly to UE1 200.

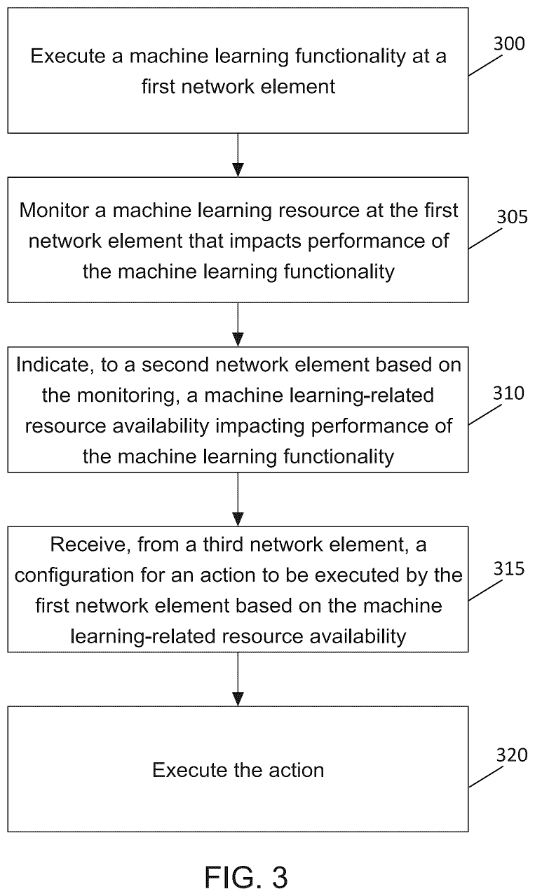

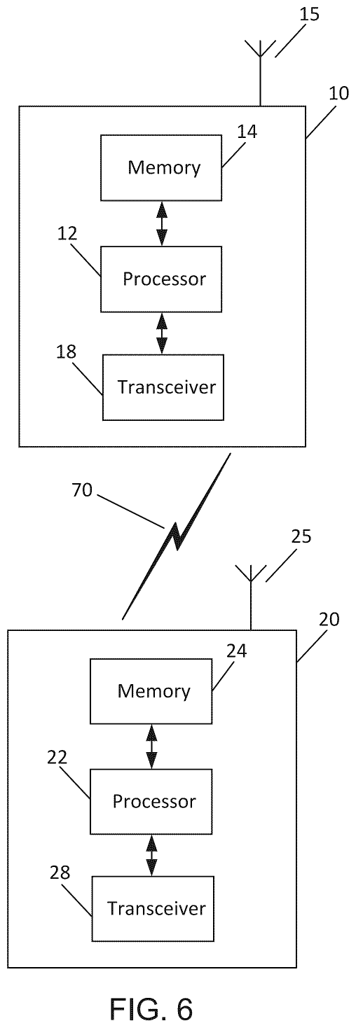

FIG. 3 illustrates an example flow diagram of a method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a UE or gNB similar to one of apparatuses 10 or 20 illustrated in FIG. 6.

According to certain example embodiments, the method of FIG. 3 may include, at 300, executing a machine learning functionality, feature, or model at a first network element. The method may also include, at 305, monitoring a machine learning resource at the first network element that impacts performance of the machine learning functionality, feature, or model. In certain example embodiments, the machine learning resource itself may be required to perform/execute a certain ML functionality, feature, or model. The method may further include, at 310, indicating, to a second network element based on the monitoring, a machine learning-related resource availability impacting performance of the machine learning functionality, feature, or model. In addition, the method may include, at 315, receiving, from a third network element, a configuration for an action to be executed by the first network element based on the machine learning-related resource availability impacting performance of the machine learning functionality, feature, or model. Further, the method may include, at 320, executing the action.

According to certain example embodiments, the method may further include receiving a trigger from the second network element to monitor a resource availability of the first network element impacting the machine learning functionality, feature, or model. According to some example embodiments, the machine learning resource may include at least one of a processing power, an availability memory, electrical power, a device input or output condition, or a device connection status. According to other example embodiments, the machine learning-related resource availability impacting performance of the machine learning functionality, feature, or model may be provided by at least one of a binary indication of whether there are sufficient machine learning-related resources at the first network element to run a specified machine learning-enabled feature, functionality, or model, a performance status of the machine learning functionality, the performance status related to time or space, or an update on a status of the machine learning-related resource, the update comprising an amount or percentage of power or memory consumed, required, or available.

In certain example embodiments, the action to be executed by the first network element may include at least selecting, activating, deactivating, switching, or falling back to another machine learning functionality, feature, or model. In some example embodiments, the selecting, activating, deactivating, switching, or falling back to the another machine learning functionality may be executed based on at least one timer or at least one threshold on the machine learning functionality, feature, or model. The action to be executed by the first network element may further or alternatively include at least receiving a new model that the first network element should switch to. In other example embodiments, indicating the machine learning-related resource availability impacting performance of the machine learning functionality, feature, or model may include indicating the machine learning-related resource availability impacting performance of the machine learning functionality, feature, or model to another first network element executing the same machine learning functionality, feature, or model. In further example embodiments, the second network element and the third network element may be combined as a single network element.

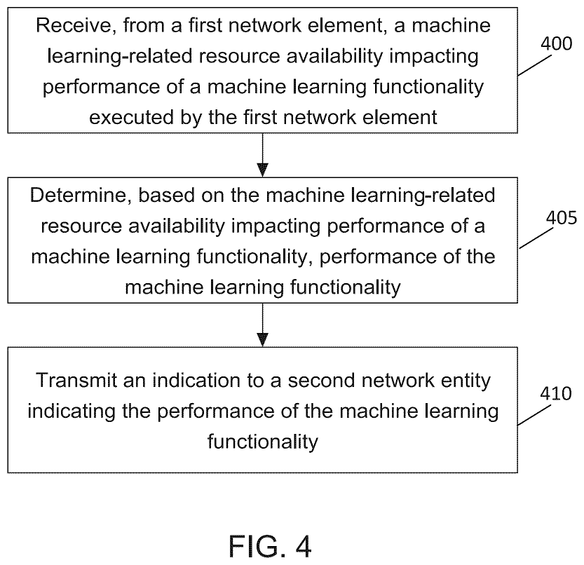

FIG. 4 illustrates an example flow diagram of another method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a core network entity or functionality such as, for example, a performance monitoring entity similar to one of apparatuses 10 or 20 illustrated in FIG. 6.

According to certain example embodiments, the method of FIG. 4 may include, at 400, receiving, from a first network element, a machine learning-related resource availability impacting performance of a machine learning functionality, feature, or model executed by the first network element. The method may also include, at 405, determining, based on the machine learning-related resource availability impacting performance of the machine learning functionality, feature, or model, a performance of the machine learning functionality, feature, or model. The method may further include, at 410, transmitting an indication to a second network entity or the first network element indicating the performance of the machine learning functionality, feature, or model.

According to certain example embodiments, the method may also include triggering the first network element to monitor a resource availability of the first network element impacting the machine learning functionality, feature, or model. According to some example embodiments, the machine learning-related resource availability impacting performance of the machine learning functionality, feature, or model may be received by at least one of a binary indication of whether there are sufficient machine learning-related resources at the first network element to run a specified machine learning-enabled feature, functionality, or model, a performance status of the machine learning functionality, the performance status related to time or space, or an update on a status of the machine learning-related resource, the update comprising an amount or percentage of power or memory consumed, required, or available.

In certain example embodiments, the method may further include updating the machine learning functionality, feature, or model based on machine learning-related resource availability impacting performance of the machine learning functionality, feature, or model. In some example embodiments, the method may also include informing the first network element of the updated machine learning functionality, feature, or model.

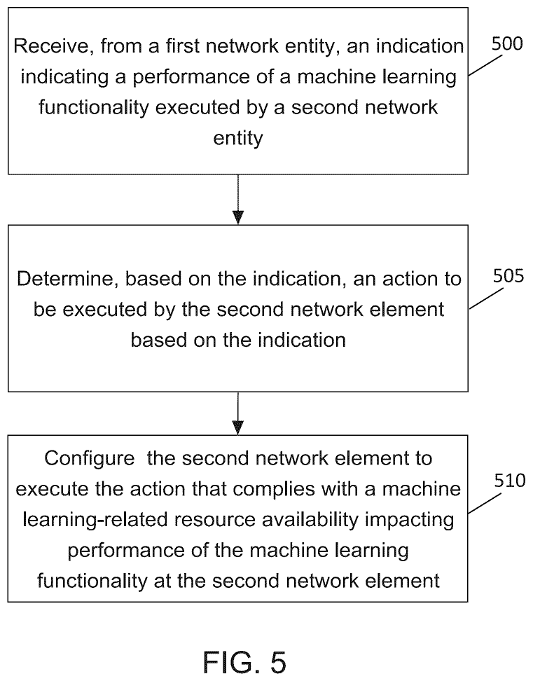

FIG. 5 illustrates an example flow diagram of another method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a core network entity or functionality such as, for example, a functionality managing entity similar to one of apparatuses 10 or 20 illustrated in FIG. 6.

According to certain example embodiments, the method of FIG. 4 may include, at 500, receiving, from a first network entity, an indication indicating a performance of a machine learning functionality, feature, or model executed by a second network entity. The method may also include, at 505, determining, based on the indication, an action to be executed by the second network element based on the indication. The method may further include, at 510, configuring the second network element to execute the action that complies with a machine learning-related resource availability impacting performance of the machine learning functionality, feature, or model at the second network element.

According to certain example embodiments, the action to be executed by the second network element comprises at least selecting, activating, deactivating, switching, or falling back to another machine learning functionality, feature, or model. According to certain example embodiments, the selecting, activating, deactivating, switching, or falling back to the another machine learning functionality may be executed based on at least one timer or at least one threshold on the machine learning functionality, feature, or model. According to other example embodiments, the action to be executed by the second network element may further or alternatively include at least receiving a new model that the first network element should switch to.

In certain example embodiments, the method may further include updating the machine learning functionality based on machine learning-related resource availability impacting performance of the machine learning functionality. In some example embodiments, the method may also include informing the second network element and a third network element of the updated machine learning functionality.

FIG. 6 illustrates a set of apparatuses 10 and 20 according to certain example embodiments. In certain example embodiments, apparatuses 10 and 20 may be elements in a communications network or associated with such a network. For example, apparatus 10 may be a UE or other similar radio communication computer device, and apparatus 20 may be a network (i.e., gNB, performance network monitoring entity, or functionality managing entity).

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 6.

As illustrated in the example of FIG. 6, apparatuses 10 and 20 may include or be coupled to a processors 12 and 22 for processing information and executing instructions or operations. Processors 12 and 22 may be any type of general or specific purpose processor. In fact, processors 12 and 22 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processors 12 and 22 is shown in FIG. 6, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-5.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-5.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to execute a machine learning functionality, feature, or model at the apparatus. Apparatus 10 may also be controlled by memory 14 and processor 12 to monitor a machine learning resource at the apparatus that impacts performance of the machine learning functionality, feature, or model. Apparatus 10 may further be controlled by memory 14 and processor 12 to indicate, to a first network element based on the monitoring, a machine learning-related resource availability impacting performance of the machine learning functionality, feature, or model. In addition, apparatus 10 may be controlled by memory 14 and processor 12 to receive, from a second network element, a configuration for an action to be executed by the apparatus based on the machine learning-related resource availability impacting performance of the machine learning functionality, feature, or model. Further, apparatus 10 may be controlled by memory 14 and processor 12 to execute the action.

In other certain example embodiments, apparatus 20 may be controlled by memory 24 and processor 22 to receive, from a first network element, a machine learning-related resource availability impacting performance of a machine learning functionality, feature, or model executed by the first network element. Apparatus 20 may also be controlled by memory 24 and processor 22 to determine, based on the machine learning-related resource availability impacting performance of the machine learning functionality, feature, or model, a performance of the machine learning functionality, feature, or model. Apparatus 20 may further be controlled by memory 24 and processor 22 to transmit an indication to a second network entity or the first network element indicating the performance of the machine learning functionality, feature, or model.

In further example embodiments, apparatus 20 may be controlled by memory 24 and processor 22 to receive, from a first network entity, an indication indicating a performance of a machine learning functionality, feature, or model executed by a second network entity. Apparatus 20 may also be controlled by memory 24 and processor 22 to determine, based on the indication, an action to be executed by the second network element based on the indication. Apparatus 20 may further be controlled by memory 24 and processor 22 to configure the second network element to execute the action that complies with a machine learning-related resource availability impacting performance of the machine learning functionality, feature, or model at the second network element.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for executing a machine learning functionality, feature, or model at the apparatus. The apparatus may also means for monitoring a machine learning resource at the apparatus that impacts performance of the machine learning functionality, feature, or model. The apparatus may further include means for indicating, to a first network element based on the monitoring, a machine learning-related resource availability impacting performance of the machine learning functionality, feature, or model. In addition, the apparatus may include means for receiving, from a second network element, a configuration for an action to be executed by the apparatus based on the machine learning-related resource availability impacting performance of the machine learning functionality, feature, or model. Further, the apparatus may include means for executing the action.

Additional example embodiments may be directed to an apparatus that includes means for receiving, from a first network element, a machine learning-related resource availability impacting performance of a machine learning functionality, feature, or model executed by the first network element. The apparatus may also include means for determining, based on the machine learning-related resource availability impacting performance of the machine learning functionality, feature, or model, a performance of the machine learning functionality, feature, or model. The apparatus may further include means for transmitting an indication to a second network entity or the first network element indicating the performance of the machine learning functionality, feature, or model.

Further example embodiments may be directed to an apparatus that includes means for receiving, from a first network entity, an indication indicating a performance of a machine learning functionality, feature, or model executed by a second network entity. The apparatus may also include means for determining, based on the indication, an action to be executed by the second network element based on the indication. The apparatus may further include means for configuring the second network element to execute the action that complies with a machine learning-related resource availability impacting performance of the machine learning functionality, feature, or model at the second network element.

Certain example embodiments described herein provide several technical improvements, enhancements, and/or advantages. For instance, in some example embodiments, it may be possible to provide a method to select, activate, deactivate, switch, and/or fallback AI/ML-enabled feature, functionality, or model at the UE or RAN node depending on the conditions of AI/ML-related resource availability at the UE or RAN node side. According to other example embodiments, it may be possible to improve the performance of ML-enabled features (e.g., better accuracy of UE location estimation, etc.) with timely configuration of the ML functionalities by taking into account resource availability conditions at the ML performing entity.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
AI Artificial Intelligence
BS Base Station
CPU Central Processing Unit
CSI Channel State Information
DL Downlink
eNB Enhanced Node B
E-UTRAN Evolved UTRAN
FG Feature Group
gNB 5G or Next Generation Node B
GPU Graphics Processing Unit
ID Identification
KPI Key Performance Indicators
LCM Lifecycle Management
LMF Location Management Function
LTE Long Term Evolution
ML Machine Learning
NR New Radio
NW Network
AM Random Access Memory
RAN Radio Access Network
ROM Read-Only Memory
TPU Tensor Processing Unit
UE User Equipment
UL Uplink

We claim:

1. An apparatus, comprising:
at least one processor; and
at least one memory comprising computer program code,
wherein the at least one memory and the computer program code are configured to, with the at least one processor, cause the apparatus at least to
execute a machine learning functionality, feature, or model at the apparatus;
monitor a machine learning resource at the apparatus that impacts performance of the machine learning functionality, feature, or model;
indicate, to a first network entity based on the monitoring, a machine learning-related resource availability impacting performance of the machine learning functionality, feature, or model;
receive, from a second network entity, a configuration for an action to be executed by the apparatus based on the machine learning-related resource availability impacting performance of the machine learning functionality, feature, or model; and
execute the action.

2. The apparatus according to claim 1, wherein the at least one memory and the computer program code are further configured to, with the at least one processor, cause the apparatus at least to:
receive a trigger from the first network entity to monitor a resource availability of the apparatus impacting the machine learning functionality, feature, or model.

3. The apparatus according to claim 1, wherein the machine learning resource comprises at least one of the following:
a processing power,
an availability memory,
electrical power,
a device input or output condition, or
a device connection status.

4. The apparatus according to claim 1, wherein the machine learning-related resource availability impacting performance of the machine learning functionality, feature, or model is provided by at least one of the following:
a binary indication of whether there are sufficient machine learning-related resources at the apparatus to run a specified machine learning-enabled feature, functionality, or model,
a performance status of the machine learning functionality, the performance status related to time or space, or
an update on a status of the machine learning-related resource, the update comprising an amount or percentage of power or memory consumed, required, or available.

5. The apparatus according to claim 1, wherein the action to be executed by the apparatus comprises at least one of the following:
selecting, activating, deactivating, switching, or falling back to another machine learning functionality, feature, or model, wherein the selecting, activating, deactivating, switching, or falling back to the another machine learning functionality are executed based on at least one timer or at least one threshold on the machine learning functionality, feature, or model, or
receiving a new model that the apparatus should switch to.

6. The apparatus according to claim 1, wherein indicating the machine learning-related resource availability impacting performance of the machine learning functionality, feature, or model comprises indicating the machine learning-related resource availability impacting performance of the machine learning functionality, feature, or model to another apparatus executing the same machine learning functionality, feature, or model.

7. The apparatus according to claim 1, wherein the first network entity and the second network entity are combined as a single network entity.

8. The apparatus according to claim 1, wherein the apparatus is comprised in a user equipment or gNB; the first network entity is a performance monitoring entity, and the second network entity is a functionality managing entity.

9. An apparatus, comprising:
at least one processor; and
at least one memory comprising computer program code,
wherein the at least one memory and the computer program code are configured to, with the at least one processor, cause the apparatus at least to
receive, from a first network entity, a machine learning-related resource availability impacting performance of a machine learning functionality, feature, or model executed by the first network element;
determine, based on the machine learning-related resource availability impacting performance of the machine learning functionality, feature, or model, a performance of the machine learning functionality, feature, or model; and
transmit an indication to a second network entity or the first network entity indicating the performance of the machine learning functionality, feature, or model.

10. The apparatus according to claim 9, wherein the at least one memory and the computer program code are further configured to, with the at least one processor, cause the apparatus at least to:
trigger the first network entity to monitor a resource availability of the first network entity impacting the machine learning functionality, feature, or model.

11. The apparatus according to claim 9, wherein the machine learning-related resource availability impacting performance of the machine learning functionality, feature, or model is received by at least one of the following:
a binary indication of whether there are sufficient machine learning-related resources at the first network entity to run a specified machine learning-enabled feature, functionality, or model,
a performance status of the machine learning functionality, the performance status related to time or space, or
an update on a status of the machine learning-related resource, the update comprising an amount or percentage of power or memory consumed, required, or available.

12. The apparatus according to claim 9, wherein the at least one memory and the computer program code are further configured to, with the at least one processor, cause the apparatus at least to:
update the machine learning functionality, feature, or model based on machine learning-related resource availability impacting performance of the machine learning functionality, feature, or model.

13. The apparatus according to claim 12, wherein the at least one memory and the computer program code are further configured to, with the at least one processor, cause the apparatus at least to:
inform the first network entity of the updated machine learning functionality, feature, or model.

14. The apparatus of claim 9, wherein the apparatus is comprised in a performance monitoring entity, the first network entity is a user equipment or a gNB, and the second network entity is a functionality managing entity.

15. An apparatus, comprising:
at least one processor; and
at least one memory comprising computer program code,
wherein the at least one memory and the computer program code are configured to, with the at least one processor, cause the apparatus at least to
receive, from a first network entity, an indication indicating a performance of a machine learning functionality, feature, or model executed by a second network entity;
determine, based on the indication, an action to be executed by the second network entity based on the indication; and
configure the second network entity to execute the action that complies with a machine learning-related resource availability impacting performance of the machine learning functionality, feature, or model at the second network entity.

16. The apparatus according to claim 15, wherein the action to be executed by the second network entity comprises at least one of the following:
selecting, activating, deactivating, switching, or falling back to another machine learning functionality, feature, or model, wherein the selecting, activating, deactivating, switching, or falling back to the another machine learning functionality are executed based on at least one timer or at least one threshold on the machine learning functionality, feature, or model, or
receiving a new model that the first network entity should switch to.

17. The apparatus according to claim 15, wherein the at least one memory and the computer program code are further configured to, with the at least one processor, cause the apparatus at least to:
update the machine learning functionality based on machine learning-related resource availability impacting performance of the machine learning functionality.

18. The apparatus according to claim 17, wherein the at least one memory and the computer program code are further configured to, with the at least one processor, cause the apparatus at least to:
inform the second network entity and a third network entity of the updated machine learning functionality.

19. The apparatus of claim 18, wherein the second network entity is a user equipment or a gNB, and the third network entity is another user equipment or another gNB.

20. The apparatus of claim 15, wherein the apparatus is comprised in a functionality managing entity, the first network entity is a performance monitoring entity.
